(19) United States
(12) Patent Application Publication
(10) Pub. No.: US 2003/0180426 A1
(43) Pub. Date: Sep. 25, 2003

(54) Bacon cooker

(76) Inventor: Sabrena A. Wright, Renton, WA (US)

Correspondence Address: Lawrence D. Graham, Esq., BLACK LOWE & GRAHAM PLLC, 816 Second Avenue, Seattle, WA, 98104, US

(21) Appl. No.: 10/394,561

(22) Filed: Mar. 21, 2003

Related U.S. Application Data
(60) Provisional application No. 60/366,709, filed on Mar. 21, 2002.

(51) Int. Cl. A23C 3/00

(52) U.S. Cl. 426/523

(57) ABSTRACT

A cooking tray for food, particularly including bacon, comprises a generally rectangular base with sidewalls that are somewhat inclined. A number of ribs or other suitable projections extend upward from the base to suspend the bacon above the grease that is produced during cooking. The lower surface of the base of the tray includes legs or other structures to facilitate a criss-crossed stacking arrangement during cooking. The sidewalls are preferably inclined somewhat to allow the trays to be nested for convenient storage of multiple trays.

### PRIORITY CLAIM

This application claims priority to application U.S. Ser. No. 60/366,709 filed Mar. 21, 2002.

### FIELD OF THE INVENTION

This invention relates generally to cookware, including a tray principally intended for cooking bacon in a microwave oven.

### BACKGROUND OF THE INVENTION

Bacon can be cooked in a variety of ways, including by baking in an oven, frying it on a pan on a range, or cooking it in a microwave oven. Of these primary alternatives, frying it is considered the most traditional method of cooking.

Cooking bacon in a microwave oven has become popular because it offers several advantages over other cooking methods. As with most foods, bacon cooks faster in a microwave oven than by other methods. Unlike frying, microwave cooking does not require constant attention to keep bacon from burning. Microwave cooking also does not cook the bacon in a bath of fat, therefore producing a healthier food than fried bacon.

Most existing microwave bacon trays are designed only for a single use—cooking bacon. Present microwave bacon trays come in round and rectangular shapes and vary in size. In the various existing trays, bacon can lie flat on the bed of the cooker, drape upright on supports, or lie on edge, held in place with stakes speared through the bacon. Because they are designed for the microwave, all current microwave bacon trays are made of plastic.

Although there are microwave bacon cooking trays presently on the market, they suffer from a number of disadvantages. Some styles of bacon trays cook the bacon in the fat because the ribs are not tall enough to keep the bacon out of the fat that cooks off the bacon. Existing bacon trays are limited in the amount of bacon they can cook at one time by the surface area of the tray. Although some microwave bacon cookers take advantage of the height of a microwave oven by using inverted V-shaped pillars rising above the tray, such devices are awkward to store and produce irregularly-shaped bacon when cooked.

Accordingly, there is a need for a microwave bacon tray that overcomes some of the above problems.

### SUMMARY OF THE INVENTION

The present tray comprises a generally rectangular base with sidewalls that are somewhat inclined. A number of ribs or other suitable projections extend upward from the base to suspend the bacon above the grease that is produced during cooking.

In accordance with other aspects of the invention, two or more trays may be stacked for simultaneous cooking. In an actual embodiment, the lower surface of the base of the tray includes legs to facilitate a criss-crossed stacking arrangement.

In accordance with yet other aspects of the invention, the sidewalls are inclined somewhat to allow the trays to be nested for convenient storage of multiple trays.

In accordance with still other aspects of the invention, the tray is suitable for additional cooking purposes, including use as a grill, defrosting tray, drying rack, or a tray for other microwaveable foods.

### BRIEF DESCRIPTION OF THE DRAWINGS

The preferred and alternative embodiments of the present invention are described in detail below with reference to the following drawings.

FIG. 1 is an isometric view of a preferred embodiment of the bacon tray;

FIG. 2 is a top plan view of a preferred embodiment of the bacon tray;

FIG. 3 is a bottom plan view of a preferred embodiment of the bacon tray;

FIG. 4 is an end view of a preferred embodiment of the bacon tray;

FIG. 5 is a side view of a preferred embodiment of the bacon tray;

FIG. 6 is a top plan view of two preferred bacon trays stacked for simultaneous cooking;

FIG. 7 is a side view of two preferred bacon trays stacked for simultaneous cooking; and

FIG. 8 is an isometric view of two preferred bacon trays nested for storage.

### DETAILED DESCRIPTION OF THE PREFERRED EMBODIMENT

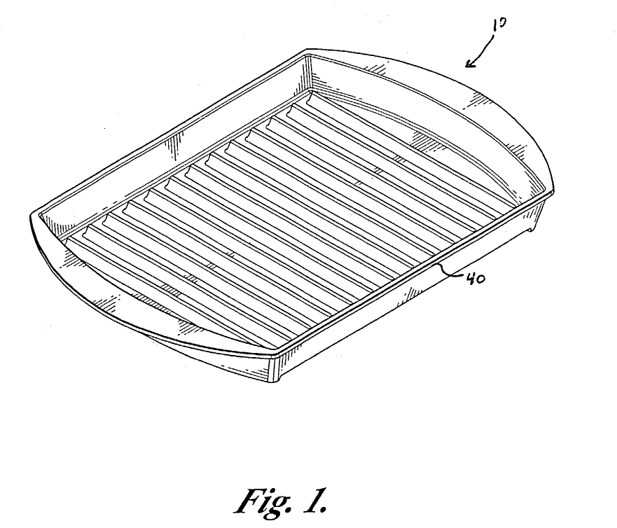

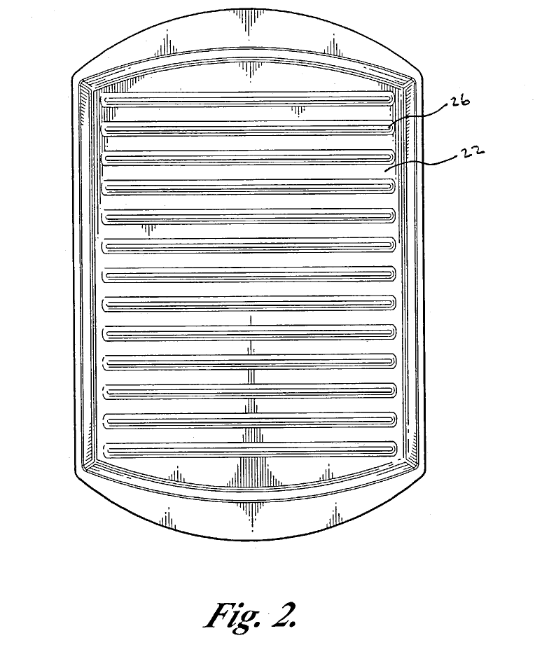

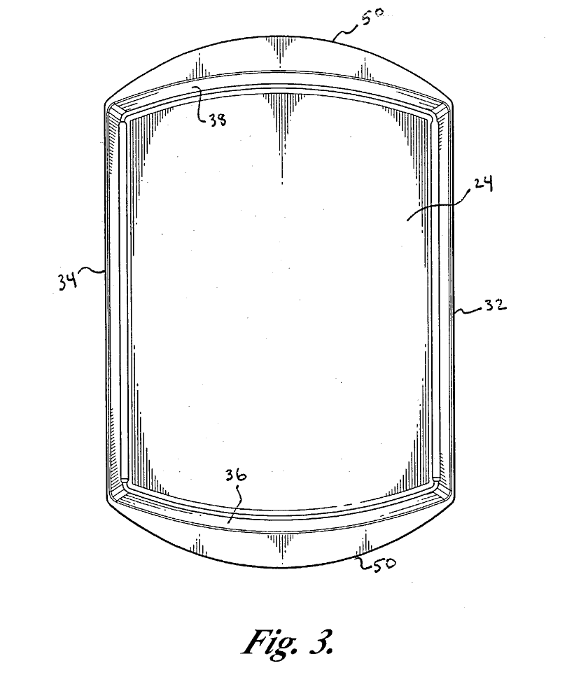

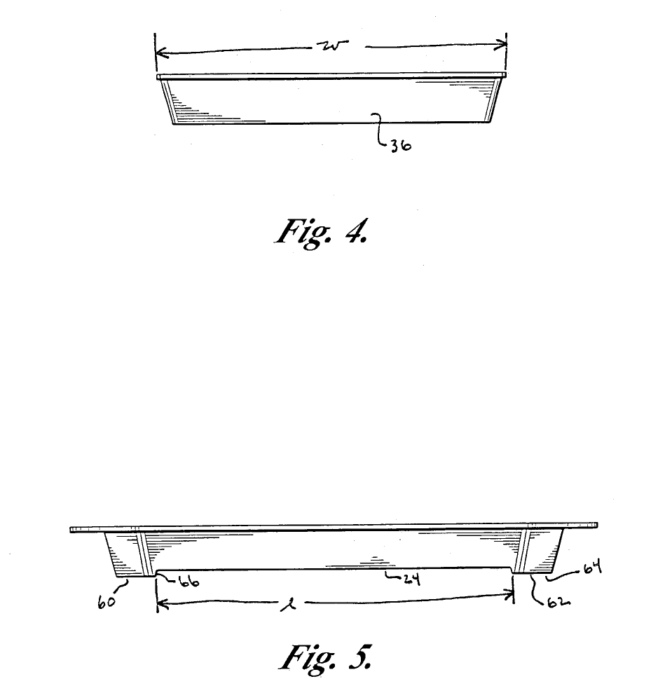

As illustrated in FIGS. 1-5, the preferred embodiment of the bacon cooking tray 10 includes a base 20 having an upper surface 22 and a lower surface 24. The base lower surface 24 is substantially flat, while the upper surface 22 includes a plurality of ribs 26 extending upward and away from the upper surface 22. Each of the ribs includes a relatively wide base adjacent the upper surface 24 of the base 20. The ends of the ribs opposite the base 20 are flat to provide a stable surface for holding bacon.

Joined to the appropriate sides and ends of the base are two opposing side walls 32, 34 and two opposing end walls 36, 38. Preferably, the side walls 32, 34 and end walls 36, 38 are inclined slightly, forming a wider opening at the tray rim 40 than the perimeter of the base 20. Accordingly, two or more trays may be nested for storage, as illustrated in FIG. 8.

In an actual embodiment, the ends of the base 20 and the corresponding end walls 36, 38 are bowed outward. Alternatively, the end walls may be straight. In yet other embodiments, the entire tray may be circular, oval, or other shapes.

The tray 10 also includes a planar handle 50 extending generally perpendicularly from each of the end walls 36, 38. As with the end walls, the handles 50 are bowed outward. The handles 50, however, are bowed even greater at the center, forming a wider hand-hold surface at the center than at the ends adjacent either of the side walls 32, 34. The bowed aspect of the handles and the wider grip area at the center also help to allow the handle to stay cool even during cooking. A wide array of alternative handle designs is also possible, consistent with this invention.

The end walls 36, 38 extend below the lower surface 24 of the base 20, while the side walls 32, 34 extend to a point adjacent the lower surface 24 of the base 20. Consequently, the lower portions of the end walls form a pair of feet 60, 62 to provide a foundation for the tray 10. Depending on the relative length and width of the side walls and end walls, a portion of each end of the side walls may also extend below the lower surface of the base 20, also forming part of the feet 60, 62. The lower surface 64 of the feet 60, 62 is therefore below the lower surface 24 of the base 20. Accordingly, the feet 60, 62 allow for air circulation below the lower surface of the base 20.

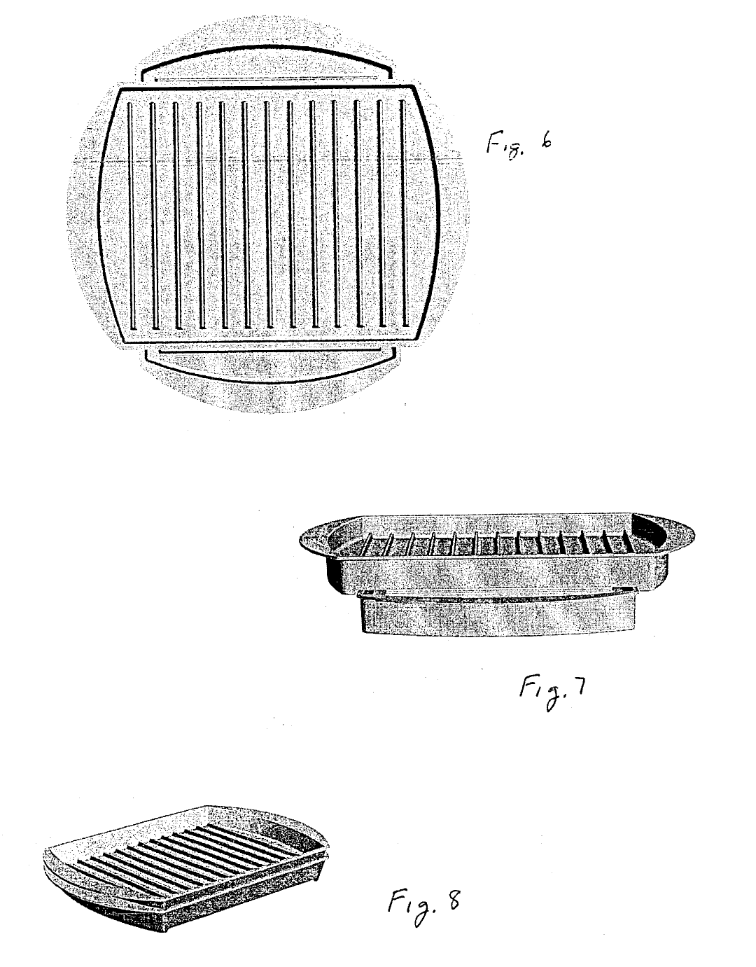

The feet 60, 62 also create one or more generally vertical engagement surfaces 66, 68 that facilitate the stacking of multiple trays during cooking. The length l is equal to or slightly greater than the width w, so that two or more trays can be stacked in “criss-cross” fashion during cooking, as illustrated in FIGS. 6-7. While the stacking ability is preferably accomplished by the use of the feet 60, 62 as described above, it can be created in other manners. For example, the lower surface 24 of the base 20 can include an indentation that is configured to receive the rim 40 of a cooking tray 10 for stacked cooking. Alternatively, pegs or other engagement devices can be used to allow multiple trays to interlock during cooking. Still further, the legs or other extensions may extend inside the rim 40 of a lower tray, rather than to the outside as with the preferred embodiment.

Just as the feet 60, 62 allow air circulation below the tray 10 during cooking, the generally rectangular shape allows for air circulation through each tray when multiple trays are stacked for cooking, as illustrated in FIG. 6.

The tray 10 is made from a rigid heat stable plastic that is microwave, freezer and dishwasher safe. Preferably, the plastic material is an injection moldable modified polyolefin.

While the preferred embodiment of the invention has been illustrated and described, as noted above, many changes can be made without departing from the spirit and scope of the invention. Accordingly, the scope of the invention is not limited by the disclosure of the preferred embodiment.

I claim:

1. A tray, comprising:
a substantially flat base having an upper surface, a lower surface, and a perimeter;
a plurality of ribs attached to and extending upward from the upper surface of the base;
a wall attached to and extending upward from substantially the entire perimeter of the base;
at least one handle attached to the wall and extending away from the base;
a first foot attached to the tray; and
a second foot attached to the tray, the first and second feet being configured such that when the tray is stacked on top of a second tray of substantially the same construction, the feet engage the wall of the second tray to allow the tray to be stacked during cooking.

2. The tray of claim 1, wherein:
the base is generally rectangular in shape, having a first side, a second side, a first end, and a second end; and
the sidewall comprises a first end wall extending upwardly from the first end, a second end wall extending upwardly from the second end, a first sidewall extending upwardly from the first side, and a second sidewall extending upwardly from the second side.

3. The tray of claim 2, wherein the distance between the first foot and the second foot is slightly greater than the distance between first end wall and the second end wall.

4. The tray of claim 2, wherein the distance between the first foot and the second foot is slightly less than the distance between the first end wall and the second end wall.

5. The tray of claim 3, wherein the distance between the first end wall and the second end wall is less than the distance between the first side wall and the second side wall.

6. The tray of claim 5, wherein the handle comprises a first handle attached to the first end wall and a second handle attached to the second end wall.

7. The tray of claim 6, wherein the first side wall, second side wall, first end wall, and second end wall are inclined sufficiently to allow the tray to be nested within a second tray.

8. The tray of claim 7, wherein the first foot is formed integral with and is a generally planar extension of the first end wall, and the second foot is formed integral with and is a generally planar extension of the second end wall.

9. The tray of claim 8, wherein the tray is constructed from injection molded modified polyolefin.

10. A tray suitable for cooking food, comprising:
a substantially flat base having an upper surface, a lower surface, and a perimeter;
a plurality of ribs attached to and extending upward from the upper surface of the base;
a wall attached to and extending upward from substantially the entire perimeter of the base;
at least one handle attached to the wall and extending away from the base; and
a means for preventing the tray from sliding in at least one direction when the tray is stacked on top of a second tray of substantially the same construction.

12. The tray of claim 11, wherein the means for preventing sliding comprises a plurality of feet extending below the lower surface of the base and configured to engage the wall of the second tray.

13. The tray of claim 11, wherein the means for preventing sliding comprises a plurality of pegs extending below the lower surface of the base and configured to engage the wall of the second tray.

14. The tray of claim 12, wherein the handle comprises a pair of generally planar handles attached to and extending generally perpendicularly outward from separate locations on the wall.

15. A method for cooking bacon, comprising:
placing bacon on a first tray, the first tray comprising (1) a substantially flat base having an upper surface, a lower surface, and a perimeter; (2) a plurality of ribs attached to and extending upward from the upper surface of the base; (3) a wall attached to and extending upward from substantially the entire perimeter of the base; and (4) a means for preventing the tray from sliding in at least one direction when the tray is stacked on top of a second tray of substantially the same construction;
stacking the second tray on top of the first tray;
placing bacon on the second tray; and
cooking the bacon.

16. The method of claim 15, wherein the means for preventing sliding comprises a plurality of feet extending below the lower surface of the base and configured to engage the wall of the second tray.

17. The method of claim 16, wherein:
the base is generally rectangular in shape, having a first side, a second side, a first end, and a second end; and
the sidewall comprises a first end wall extending upwardly from the first end, a second end wall extending upwardly from the second end, a first sidewall extending upwardly from the first side, and a second sidewall extending upwardly from the second side.

18. The method of claim 17, further comprising:
stacking a third tray on top of the second tray and placing bacon on the third tray prior to the step of cooking.

19. The method of claim 15, wherein the bacon is placed on the second tray prior to stacking the second tray on the first tray.
